(19) United States
(12) Patent Application Publication
(10) Pub. No.: US 2015/0075423 A1
(43) Pub. Date: Mar. 19, 2015

(54) SPIRAL COATING APPARATUS

(71) Applicant: Kabushiki Kaisha Toshiba, Minato-ku (JP)

(72) Inventors: Toshiyuki KISHI, Yokohama (JP); Yasuhiko Fuchikami, Yokohama (JP); Kenichi Ooshiro, Yokohama (JP)

(73) Assignee: Kabushiki Kaisha Toshiba, Minato-ku (JP)

(21) Appl. No.: 14/456,016

(22) Filed: Aug. 11, 2014

(30) Foreign Application Priority Data
Sep. 18, 2013 (JP) 2013-193286

(51) Int. Cl. B05B 15/02; B05B 3/18; B05C 11/08; B05C 5/02

(52) U.S. Cl. CPC B05B 15/0266; B05C 5/02; B05B 3/18; B05C 11/08
USPC 118/302

(57) ABSTRACT

According to one embodiment, a spiral coating apparatus includes: a stage; a nozzle; a movement unit; a gas supply unit; a cleaning liquid supply unit; and a nozzle cleaner. The stage has a placement surface. The nozzle is configured to dispense a liquid onto a coating object placed on the stage. The movement unit is configured to move the nozzle relative to the stage. The gas supply unit is configured to supply a gas. The cleaning liquid supply unit is configured to supply a cleaning liquid. The nozzle cleaner has a gas supply port and a cleaning liquid supply port. The nozzle cleaner is configured to force the gas supplied by the gas supply unit from the gas supply port toward the nozzle and dispense the cleaning liquid supplied by the cleaning liquid supply unit from the cleaning liquid supply port toward the nozzle.

### CROSS-REFERENCE TO RELATED APPLICATIONS

This application is based upon and claims the benefit of priority from Japanese Patent Application No. 2013-193286, filed on Sep. 18, 2013; the entire contents of which are incorporated herein by reference.

### FIELD

Embodiments described herein relate generally to a spiral coating apparatus.

### BACKGROUND

A spiral coating apparatus is an apparatus that forms a film on a substrate in the fields of, for example, semiconductors, etc. The spiral coating apparatus forms the film on the entire surface of a substrate having a discal configuration by fixing the substrate to a rotating stage having a circular configuration, rotating the stage, and moving a coating nozzle in a straight line from the substrate center toward the outer circumference of the substrate while dispensing a material from the coating nozzle to trace a coating path having a helical configuration (a spiral configuration). At this time, the thickness of the film can be more uniform by controlling the distance between the coating nozzle tip surface (the dispensing surface) and the substrate surface with high precision to be substantially constant.

Because the thickness of the film fluctuates when the tip of the coating nozzle is dirty, generally, the spiral coating apparatus cleans the matter adhered to the coating nozzle after the film is formed by using, for example, a cleaning liquid of an organic solvent, etc. However, the thickness of the film at the portion where the coating is started fluctuates when the cleaning liquid remains on the tip of the coating nozzle. The cleaning process of the coating nozzle is complex. Therefore, it is desirable to simplify the cleaning process of the coating nozzle.

### BRIEF DESCRIPTION OF THE DRAWINGS

FIG. 1 is a schematic plan view showing a spiral coating apparatus according to an embodiment of the invention;

FIG. 2A and FIG. 2B are schematic views showing the nozzle cleaner of the embodiment;

FIG. 3A to FIG. 3F are schematic plan views describing the effects of the nozzle cleaner and a method for cleaning the nozzle;

FIG. 4A to FIG. 4F are schematic plan views showing a method for cleaning the nozzle according to a comparative example;

FIG. 5A and FIG. 5B are schematic plan views showing a modification of the nozzle cleaner of the embodiment; and

FIG. 6A and FIG. 6B are schematic plan views showing a specific example of the wiping unit of the embodiment.

### DETAILED DESCRIPTION

In general, according to one embodiment, a spiral coating apparatus includes: a stage; a nozzle; a movement unit; a gas supply unit; a cleaning liquid supply unit; and a nozzle cleaner. The stage has a placement surface configured to have a coating object placed on the placement surface. The nozzle is configured to dispense a liquid onto the coating object placed on the stage. The movement unit is configured to move the nozzle relative to the stage. The movement unit includes a first movement mechanism part and a second movement mechanism part. The first movement mechanism part is configured to move the nozzle in a direction parallel to a rotational axis of the stage. The second movement mechanism part is configured to move the nozzle along the placement surface in a direction intersecting the rotational axis. The gas supply unit is configured to supply a gas. The cleaning liquid supply unit is configured to supply a cleaning liquid. The nozzle cleaner has a gas supply port and a cleaning liquid supply port. The nozzle cleaner is configured to force the gas supplied by the gas supply unit from the gas supply port toward the nozzle and dispense the cleaning liquid supplied by the cleaning liquid supply unit from the cleaning liquid supply port toward the nozzle.

Embodiments of the invention will now be described with reference to the drawings. Similar components in the drawings are marked with like reference numerals, and a detailed description is omitted as appropriate.

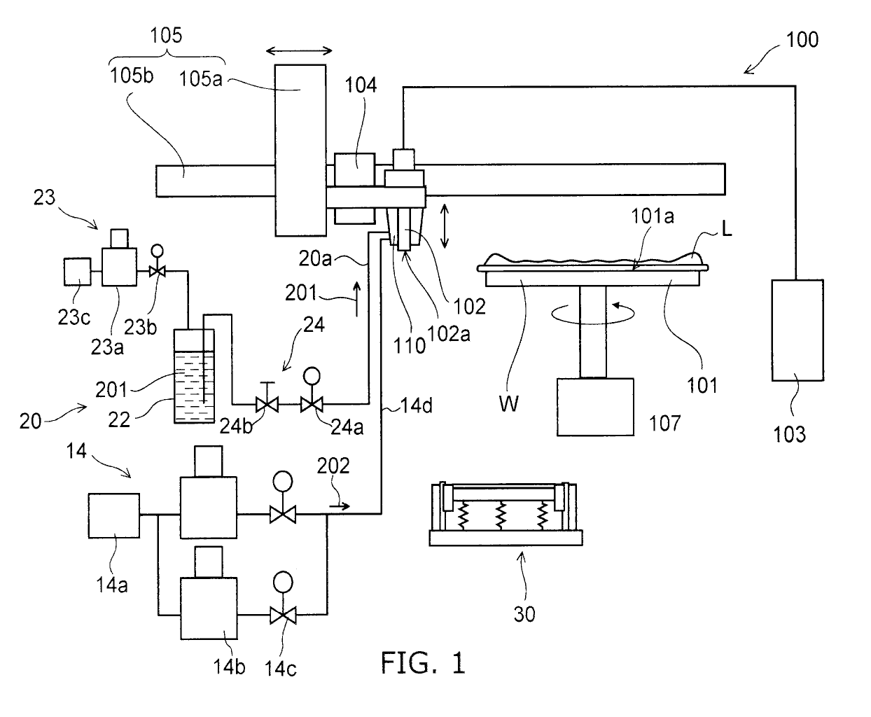

FIG. 1 is a schematic plan view showing a spiral coating apparatus according to an embodiment of the invention.

The spiral coating apparatus 100 shown in FIG. 1 includes a stage 101, a nozzle 102, a coating liquid supply unit 103, a sensor 104, a movement unit 105, a nozzle cleaner 110, a gas supply unit 14, a cleaning liquid supply unit 20, and a wiping unit 30.

A substrate W is placed on a placement surface 101a of the stage 101 as a coating object. The stage 101 holds the substrate W that is placed. The stage 101 is formed in, for example, a circular configuration and is rotatable by a drive unit 107 in a horizontal plane (in a plane along the placement surface 101a). The substrate W is held by the stage 101 by, for example, a suction mechanism using a not-shown vacuum pump, etc.

The drive unit 107 supports the stage 101 to be rotatable in the horizontal plane and rotates the stage 101 in the horizontal plane with the center of the stage 101 as the center of rotation by, for example, a motor, etc. Thereby, the substrate W that is placed on the stage 101 is rotated in the horizontal plane.

The nozzle 102 dispenses a coating liquid L from the tip of the nozzle 102 toward the surface of the substrate W. The nozzle 102 coats the coating liquid L onto the surface of the substrate W by continuously dispensing the coating liquid L. For example, the substrate W is a semiconductor wafer, etc. For example, the coating liquid L is a resist liquid, etc.

The coating liquid supply unit 103 supplies the coating liquid L to the surface of the substrate W via the nozzle 102. For example, the coating liquid supply unit 103 includes a tank, a pump, a supply valve, and a dispensing valve. The tank contains the coating liquid L. The pump supplies the coating liquid L to the nozzle 102. The supply valve and the dispensing valve are opened and closed based on a signal transmitted from a not-shown controller to control the supply of the coating liquid L to the surface of the substrate W.

The sensor 104 senses the distance to the surface of the substrate W or the placement surface 101a of the stage 101. The distance between a tip surface (a dispensing surface) 102a of the nozzle 102 and the surface of the substrate W is controlled by the not-shown controller based on the sensed distance to the surface of the substrate W. Or, the distance between the tip surface 102a of the nozzle 102 and the placement surface 101a of the stage 101 is controlled by the not-shown controller based on the sensed distance to the placement surface 101a of the stage 101. For example, a reflection-type laser sensor, etc., may be used as the sensor 104.

The movement unit 105 includes a lifting/lowering part (a first movement mechanism part) 105a and a movement part (a second movement mechanism part) 105b and moves the nozzle 102 relative to the stage 101. The lifting/lowering part 105a holds the nozzle 102 and lifts and lowers the nozzle 102. That is, the lifting/lowering part 105a moves the nozzle 102 in a direction parallel to the rotational axis of the stage 101. The movement part 105b holds the lifting/lowering part 105a and moves the nozzle 102 in a direction orthogonal to the lifting/lowering direction. That is, the movement part 105b moves the nozzle 102 along the placement surface 101a in a direction perpendicular to the rotational axis of the stage 101. For example, a robot having biaxial control, etc., may be used as the movement unit 105.

The nozzle cleaner 110 cleans the tip portion of the nozzle 102 using a gas 202 supplied by the gas supply unit 14 and a cleaning liquid 201 supplied by the cleaning liquid supply unit 20. Details of the nozzle cleaner 110 are described below.

The gas supply unit 14 includes a supply unit 14a, a pressure control unit 14b, and an open/close valve 14c and supplies the gas 202 to the nozzle cleaner 110 via a gas supply flow channel 14d. The supply unit 14a is, for example, factory piping, a tank that contains the high-pressure gas 202, etc. The pressure control unit 14b controls the pressure of the gas 202 supplied by the supply unit 14a to be within a prescribed range. The open/close valve 14c controls the supply and cut-off of the gas 202.

In such a case, a set that includes the pressure control unit 14b and the open/close valve 14c may be multiply provided. In the case where the set that includes the pressure control unit 14b and the open/close valve 14c is multiply provided, the flow velocity of the gas 202 that is forced can be switched according to the viscosity of the matter adhered to the nozzle 102, etc.

For example, for adhered matter having a low viscosity, the gas 202 can be forced via the pressure control unit 14b that has a low pressure setting. For adhered matter having a high viscosity, the gas 202 can be forced via the pressure control unit 14b that has a high pressure setting. Thereby, the adhered matter having the high viscosity can be removed easily; and scattering of the adhered matter having the low viscosity can be suppressed.

The cleaning liquid supply unit 20 includes a container 22, a liquid feed unit 23, and a flow rate control unit 24 and supplies the cleaning liquid 201 to the nozzle cleaner 110 via a cleaning liquid supply flow channel 20a.

The container 22 contains the cleaning liquid 201. The cleaning liquid 201 is not particularly limited and may be appropriately selected according to the material properties of the adhered matter. For example, in the case where the adhered matter is a resist, the cleaning liquid 201 includes a ketone solvent, an alcohol solvent, etc.

The liquid feed unit 23 forces the cleaning liquid 201 contained in the container 22 toward the nozzle cleaner 110 by supplying a gas to the interior of the container 22.

The liquid feed unit 23 includes a pressure control unit 23a, an open/close valve 23b, and a supply unit 23c.

The pressure control unit 23a controls the pressure of the gas supplied by the supply unit 23c to the interior of the container 22. The gas supplied by the supply unit 23c is not particularly limited, and includes, for example, air, nitrogen gas, etc.

The open/close valve 23b performs the supply and cut-off of the gas to the container 22.

The supply unit 23c is, for example, factory piping, a tank that contains a high-pressure gas, etc.

The flow rate control unit 24 includes a flow regulating valve 24a and an open/close valve 24b.

The flow regulating valve 24a regulates the flow rate of the cleaning liquid 201 supplied to the nozzle cleaner 110.

The open/close valve 24b performs the supply and cut-off of the cleaning liquid 201 to the nozzle cleaner 110.

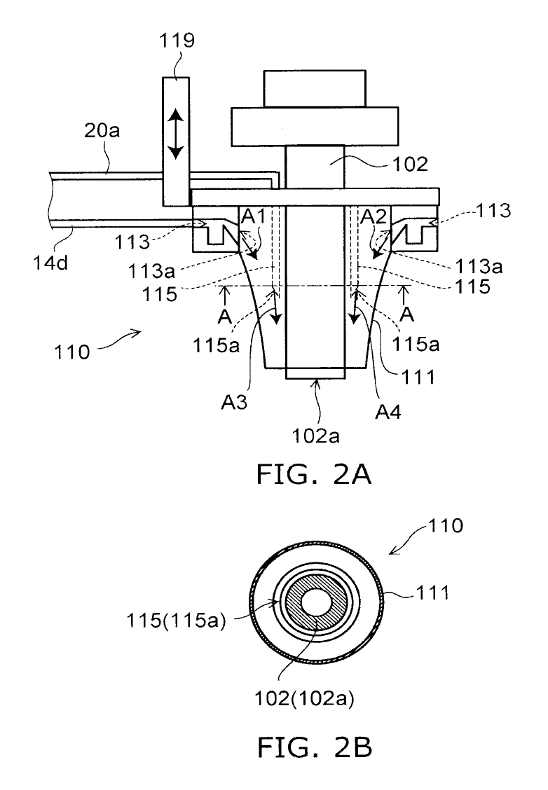

FIG. 2A and FIG. 2B are schematic views showing the nozzle cleaner of the embodiment.

FIG. 2A is a schematic plan view showing the nozzle cleaner of the embodiment. FIG. 2B is a schematic cross-sectional view of the cross-section A-A shown in FIG. 2A.

The nozzle cleaner 110 of the embodiment includes a housing 111 and a lifting/lowering mechanism part (a third movement mechanism part) 119.

The housing 111 is, for example, a container, etc., having a hollow configuration. As shown in FIG. 2A and FIG. 2B, at least a portion of the nozzle 102 is inserted into the interior of the housing 111. That is, the housing 111 covers at least a portion of the outer circumference of the nozzle 102.

The lifting/lowering mechanism part 119 holds the housing 111 and lifts and lowers the housing 111. That is, the lifting/lowering mechanism part 119 lifts and lowers the housing 111 relative to the nozzle 102 in a direction parallel to the axis of the nozzle 102. The lifting/lowering mechanism part 119 is held by the movement part 105b and can move in a direction orthogonal to the lifting/lowering direction. That is, the lifting/lowering mechanism part 119 can move with the nozzle 102 along the placement surface 101a in a direction perpendicular to the rotational axis of the stage 101. Thereby, the nozzle cleaner 110 of the embodiment can move in the lifting/lowering direction relative to the nozzle 102 and can move with the nozzle 102 along the placement surface 101a in a direction perpendicular to the rotational axis of the stage 101.

The housing 111 has a gas passage 113 and a cleaning liquid passage 115.

One end of the gas passage 113 is connected to the gas supply flow channel 14d. The other end of the gas passage 113 is a gas supply port 113a. For example, the gas passage 113 is provided in an annular configuration around the entire circumference of the nozzle 102. Or, the gas passage 113 may be multiply disposed around the entire circumference of the nozzle 102 at a prescribed spacing. As illustrated by arrows A1 and A2 of FIG. 2A, the gas 202 that is supplied via the gas supply flow channel 14d and the gas passage 113 is forced from the gas supply port 113a toward the tip portion of the nozzle 102.

One end of the cleaning liquid passage 115 is connected to the cleaning liquid supply flow channel 20a. The other end of the cleaning liquid passage 115 is used as a cleaning liquid supply port 115a. For example, the cleaning liquid passage 115 is provided in an annular configuration around the entire circumference of the nozzle 102. Or, the cleaning liquid passage 115 may be multiply disposed around the entire circumference of the nozzle 102 at a prescribed spacing. As illustrated by arrows A3 and A4 of FIG. 2A, the cleaning liquid that is supplied via the cleaning liquid supply flow channel 20a and the cleaning liquid passage 115 is dispensed from the cleaning liquid supply port 115a toward the tip portion of the nozzle 102.

As shown in FIG. 2A, the gas supply port 113a is provided to be higher than the cleaning liquid supply port 115a.

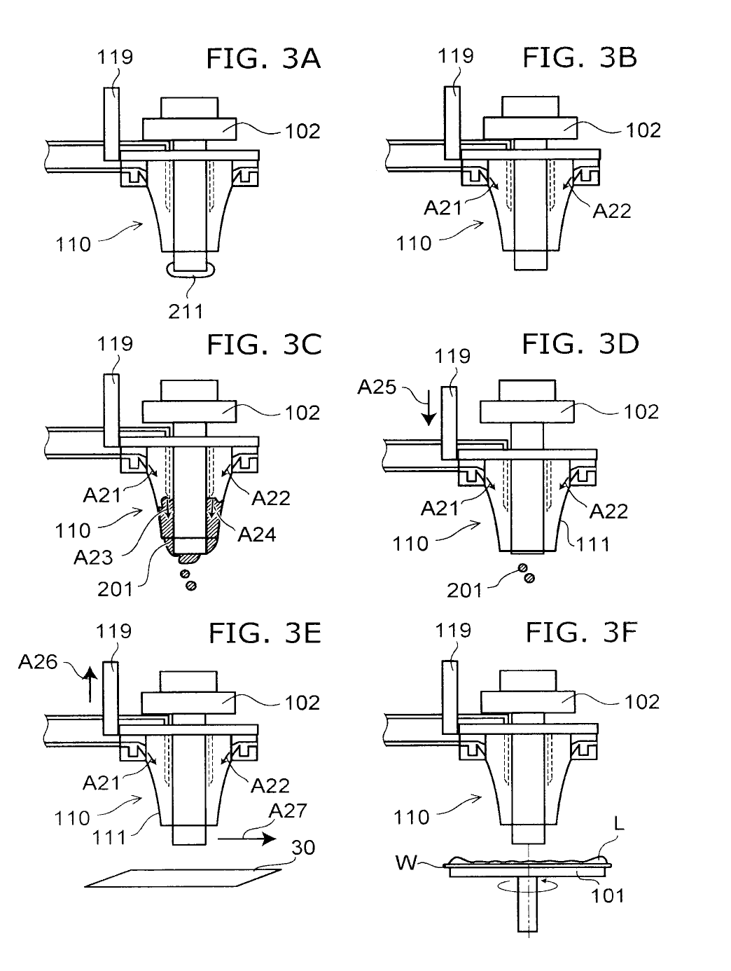

FIG. 3A to FIG. 3F are schematic plan views describing the effects of the nozzle cleaner and a method for cleaning the nozzle.

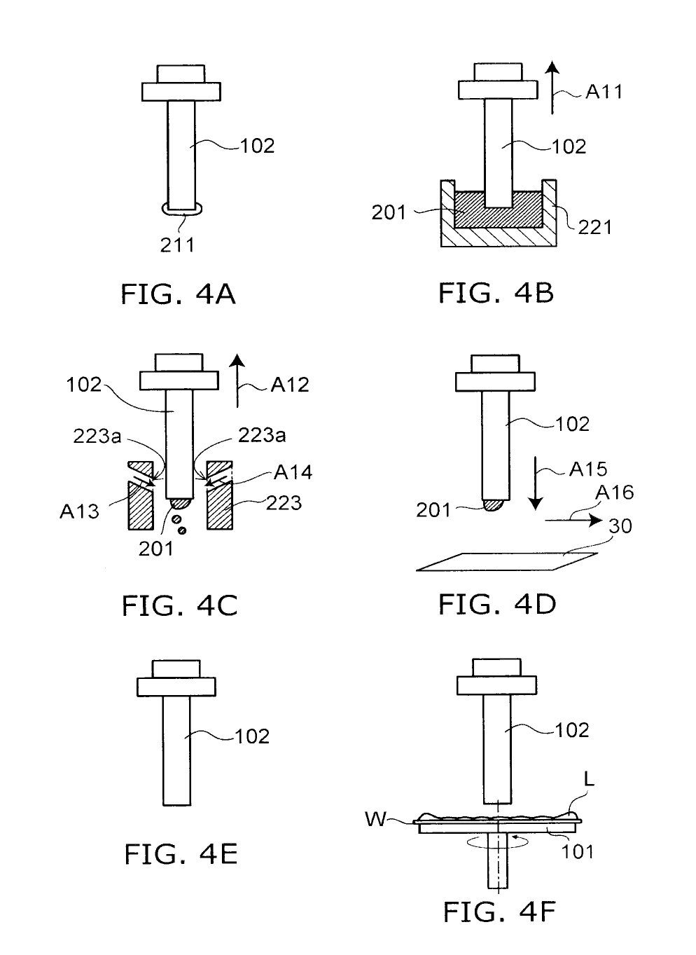

FIG. 4A to FIG. 4F are schematic plan views showing a method for cleaning the nozzle according to a comparative example.

First, the method for cleaning the nozzle according to the comparative example will be described with reference to FIG. 4A to FIG. 4F.

As shown in FIG. 4A, a gas is appropriately forced onto the tip portion of the nozzle 102 to which adhered matter 211 is adhered. Continuing as shown in FIG. 4B, the movement unit 105 moves the nozzle 102 to insert the tip portion of the nozzle 102 into the cleaning liquid 201 contained in a cleaning bath 221. Then, the coating liquid L is dispensed from the nozzle 102. Because the tip portion of the nozzle 102 is inserted into the cleaning liquid 201, the cleaning liquid 201 mixes into the coating liquid L at the tip portion of the nozzle 102. Therefore, the coating liquid L into which the cleaning liquid 201 is mixed is discharged.

Continuing as illustrated by arrow A11 of FIG. 4B and as shown in FIG. 4C, the movement unit 105 moves the nozzle 102 to insert the nozzle 102 into a blowing container 223. Then, as illustrated by arrow A13 and arrow A14 of FIG. 4C, a gas is forced from a jet hole 223a of the blowing container 223 onto the tip portion of the nozzle 102.

Continuing as illustrated by arrow A12 of FIG. 4C, the movement unit 105 moves the nozzle 102 above the wiping unit 30. Then, as illustrated by arrow A15 and arrow A16 of FIG. 4D, the tip surface 102a of the nozzle 102 is wiped by bringing the tip surface 102a of the nozzle 102 into contact with the cloth part of the wiping unit 30 and moving the tip surface 102a over the cloth part of the wiping unit 30 in the contacting state.

Continuing as shown in FIG. 4E, the movement unit 105 moves the nozzle 102 and leaves the nozzle 102 idle as-is. Thereby, the cleaning liquid 201 that is adhered to the tip surface 102a of the nozzle 102 and the tip portion of the nozzle 102 is dried. Continuing as shown in FIG. 4F, the movement unit 105 moves the nozzle 102 above the stage 101 and performs the spiral coating.

Thus, in the method for cleaning the nozzle 102 according to the comparative example, the cleaning liquid 201 that is adhered to the tip surface 102a of the nozzle 102 and the tip portion of the nozzle 102 is dried by leaving the nozzle 102 idle. Therefore, the cleaning process of the nozzle 102 may take a relatively long time. Also, the movement of the nozzle 102 may take a relatively long time when, for example, the nozzle 102 is moved from the cleaning bath 221 to the blowing container 223.

Conversely, in the embodiment, the spiral coating apparatus 100 includes the nozzle cleaner 110. As described above in regard to FIG. 2A and FIG. 2B, the nozzle cleaner 110 can move relative to the nozzle 102 in the lifting/lowering direction and can move with the nozzle 102 along the placement surface 101a in the direction perpendicular to the rotational axis of the stage 101.

The method for cleaning the nozzle 102 of the embodiment will now be described with reference to FIG. 3A to FIG. 3F.

As illustrated by arrow A21 and arrow A22 of FIG. 3B, the gas 202 is forced from the gas supply port 113a toward the tip portion of the nozzle 102 in the state in which the adhered matter 211 is adhered to the tip portion of the nozzle 102 as shown in FIG. 3A.

Continuing, the cleaning liquid 201 is dispensed from the cleaning liquid supply port 115a toward the tip portion of the nozzle 102 as illustrated by arrow A23 and arrow A24 of FIG. 3C while the gas 202 is forced from the gas supply port 113a toward the tip portion of the nozzle 102 as illustrated by, for example, arrow A21 and arrow A22 of FIG. 3C. Thereby, the cleaning liquid 201 reaches substantially the entire circumference of the tip portion of the nozzle 102.

Then, as illustrated by arrow A21, arrow A22, and arrow A25 of FIG. 3D, the lifting/lowering mechanism part 119 lowers the housing 111 toward the tip portion of the nozzle 102 while forcing the gas 202 from the gas supply port 113a toward the tip portion of the nozzle 102. Thereby, the cleaning liquid 201 that is adhered to substantially the entire circumference of the tip portion of the nozzle 102 is blown off.

Continuing, the nozzle 102 is moved above the wiping unit 30 by the movement unit 105 while the gas 202 is forced from the gas supply port 113a toward the tip portion of the nozzle 102. As described above, the gas supply port 113a is provided to be higher than the cleaning liquid supply port 115a. Thereby, the cleaning liquid 201 that re-adheres to and remains on the tip portion of the nozzle 102 after the cleaning liquid 201 adhered to the tip portion of the nozzle 102 is blown off by the gas 202 can be suppressed.

As illustrated by arrow A21, arrow A22, and arrow A26 of FIG. 3E, the lifting/lowering mechanism part 119 lifts the housing 111 toward the side opposite to the tip portion of the nozzle 102 while the gas 202 is forced from the gas supply port 113a toward the tip portion of the nozzle 102. Continuing, for example, the tip surface 102a of the nozzle 102 is wiped by bringing the tip surface 102a of the nozzle 102 into contact with the cloth part of the wiping unit 30 and moving the tip surface 102a over the cloth part of the wiping unit 30 in the contacting state as illustrated by arrow A27 of FIG. 3E while the gas 202 is forced from the gas supply port 113a toward the tip portion of the nozzle 102 as illustrated by arrow A21 and arrow A22 of FIG. 3E.

Continuing as shown in FIG. 3F, the gas 202 that was being forced from the gas supply port 113a is stopped; the nozzle 102 is moved above the stage 101 by the movement unit 105; and the spiral coating is performed.

According to the embodiment, the process of drying the tip portion of the nozzle 102 by leaving the nozzle 102 idle can be omitted. Therefore, the time for the cleaning process of the nozzle 102 can be reduced; and the cleaning process of the nozzle 102 can be simplified. Also, the gas 202 can be continuously forced from the gas supply port 113a toward the tip portion of the nozzle 102 partway through moving the nozzle 102, partway through wiping the tip surface 102a of the nozzle 102 with the wiping unit 30, etc. Thereby, the drying can be promoted; and the time for the cleaning process of the nozzle 102 can be reduced.

Also, because the cleaning bath 221 described above in regard to FIG. 4B is unnecessary, the spiral coating apparatus 100 can be compact; and the spiral coating apparatus 100 can be simplified. Further, because the cleaning liquid 201 is dispensed onto the tip portion of the nozzle 102 and the gas 202 is forced onto the tip portion of the nozzle 102, the cleaning efficiency of the nozzle 102 can be higher than in the case where the tip portion of the nozzle 102 is inserted into the cleaning liquid 201 contained in the cleaning bath 221.

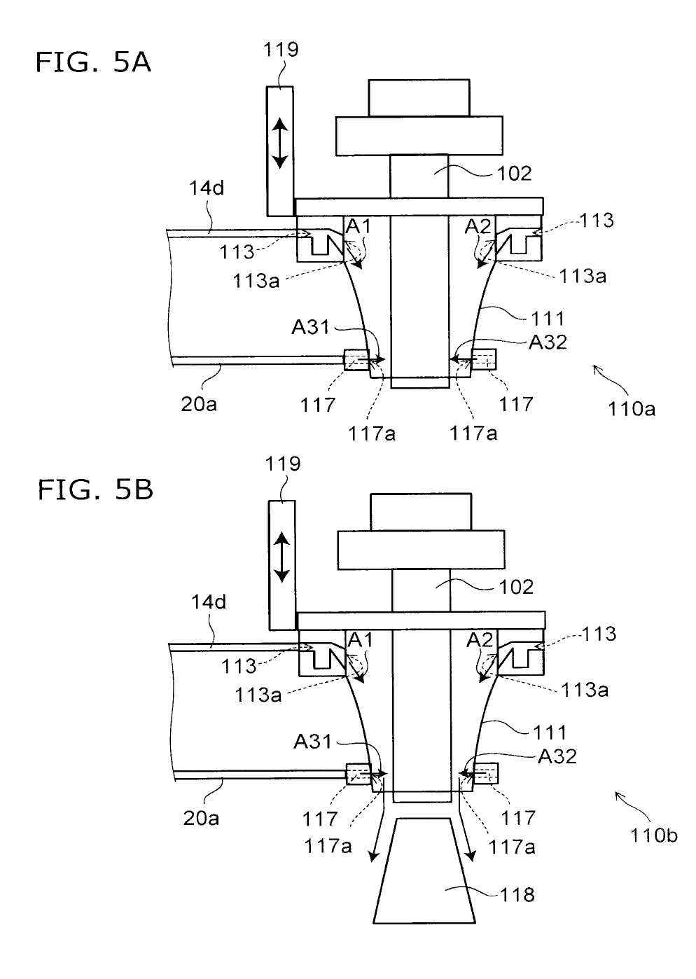

FIG. 5A and FIG. 5B are schematic plan views showing a modification of the nozzle cleaner of the embodiment.

FIG. 5A is a schematic plan view showing an example of the modification of the nozzle cleaner. FIG. 5B is a schematic plan view showing another example of the modification of the nozzle cleaner.

A nozzle cleaner 110a shown in FIG. 5A has a cleaning liquid passage 117. The cleaning liquid passage 117 is provided at the outer circumferential portion of the lower end portion of the housing 111. One end of the cleaning liquid passage 117 is connected to the cleaning liquid supply flow channel 20a. The other end of the cleaning liquid passage 117 is used as a cleaning liquid supply port 117a. For example, the cleaning liquid passage 117 is provided in an annular configuration around the entire circumference of the tip portion of the nozzle 102. Or, the cleaning liquid passage 117 may be multiply disposed around the entire circumference of the tip portion of the nozzle 102 at a prescribed spacing. As illustrated by arrow A31 and arrow A32 of FIG. 5A, the cleaning liquid that is supplied via the cleaning liquid supply flow channel 20a and the cleaning liquid passage 117 is squirted from the cleaning liquid supply port 117a toward the tip portion of the nozzle 102. Otherwise, the structure is similar to the structure of the nozzle cleaner 110 described above in regard to FIG. 2A and FIG. 2B.

According to the modification, the nozzle cleaner 110a squirts the cleaning liquid 201 from the cleaning liquid supply port 117a toward the tip portion of the nozzle 102. Therefore, the cleaning liquid 201 can reach substantially the entire circumference of the tip portion of the nozzle 102 more reliably. It is favorable for the gas 202 that is forced from the gas supply port 113a to be a laminar flow when flowing through the housing 111. Thereby, the coating liquid L at the tip portion of the nozzle 102 that is sucked from the nozzle 102 by the flow of the gas 202 can be suppressed.

Compared to the nozzle cleaner 110a shown in FIG. 5A, a nozzle cleaner 110b shown in FIG. 5B further includes a pedestal 118. Thereby, the gas 202 that is forced from the gas supply port 113a can easily have a laminar flow when flowing through the housing 111. Thereby, the coating liquid L at the tip portion of the nozzle 102 that is sucked from the nozzle 102 by the flow of the gas 202 can be suppressed more easily.

A specific example of the wiping unit 30 of the embodiment will now be described with reference to the drawings.

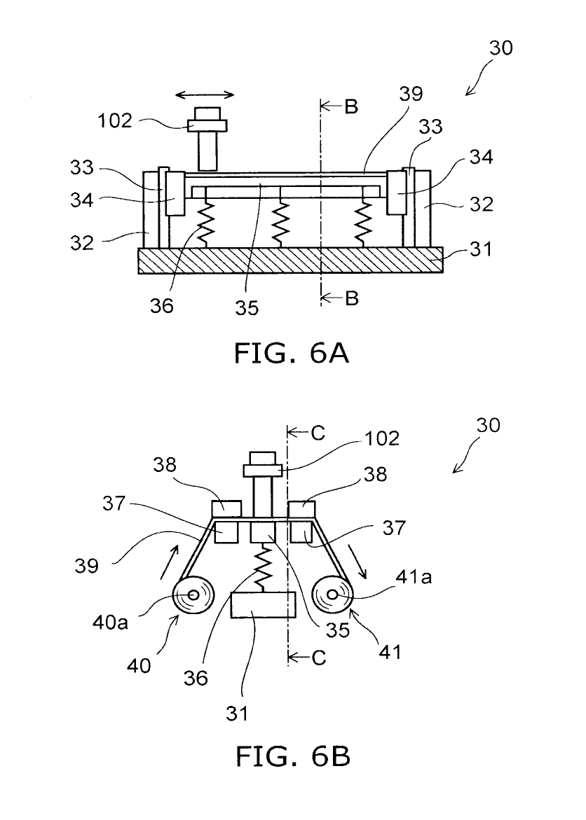

FIG. 6A and FIG. 6B are schematic plan views showing a specific example of the wiping unit of the embodiment.

FIG. 6A is a schematic cross-sectional view of the cross-section C-C shown in FIG. 6B. FIG. 6B is a schematic cross-sectional view of the cross-section B-B shown in FIG. 6A.

As shown in FIG. 6A and FIG. 6B, the wiping unit 30 includes a base 31, supports 32, guides 33, holders 34, a pad 35, elastic parts 36, support plates 37, pressing plates 38, a cloth part 39, a supply unit 40, and a take-up unit 41.

The base 31 has a plate configuration and is provided between the supply unit 40 and the take-up unit 41.

The supports 32 are provided respectively at the two longitudinal-direction end portions of the base 31. The supports 32 have columnar configurations.

The guides 33 are provided at the supports 32. The guides 33 extend in the axis direction of the supports 32.

The holders 34 hold the pad 35 and move along the guides 33.

The pad 35 contacts the side of the cloth part 39 opposite to the side which the tip surface of the nozzle 102 contacts. The pad 35 has a plate configuration; and the two end portions of the pad 35 are held by the holders 34. The longitudinal direction of the pad 35 is the same as the longitudinal direction of the base 31.

The elastic parts 36 are provided between the base 31 and the pad 35 and urge the pad 35 toward the cloth part 39. The elastic parts 36 are, for example, compression springs, etc.

The support plates 37 contact the side of the cloth part 39 opposite to the side which the tip surface of the nozzle 102 contacts. Two support plates 37 are provided with the pad 35 interposed in a direction orthogonal to the longitudinal direction of the pad 35. The support plates 37 are held by, for example, the supports 32.

The pressing plates 38 are provided respectively above the two support plates 37. In other words, the pressing plates 38 are provided to face the support plates 37 with the cloth part 39 interposed between the pressing plates 38 and the support plates 37. The pressing plates 38 are urged toward the support plates 37 by not-shown elastic parts.

Although the case is shown in which two sets of the support plate 37 and the pressing plate 38 are provided, the number of sets may be modified appropriately. For example, one set of the support plate 37 and the pressing plate 38 may be provided; or three or more sets may be provided.

The cloth part 39 has a band configuration. One end of the cloth part 39 is held by a roll 40a of the supply unit 40; and the other end of the cloth part 39 is held by a roll 41a of the take-up unit 41.

The cloth part 39 passes between the support plate 37 and the pressing plate 38 on the supply unit 40 side, over the upper surface of the pad 35, and between the support plate 37 and the pressing plate 38 on the take-up unit 41 side.

The tip surface of the nozzle 102 can be wiped by bringing the tip surface of the nozzle 102 into contact with the cloth part 39 and moving the tip surface over the cloth part 39 in the contacting state. At this time, the cloth part 39 is pressed onto the tip surface of the nozzle 102 by the pad 35 due to the effect of the elastic parts 36. Therefore, the adhesion between the cloth part 39 and the tip surface of the nozzle 102 can be maintained.

The supply unit 40 holds the roll 40a onto which the cloth part 39 is wound. The roll 40a is rotatable.

The take-up unit 41 holds the roll 41a. The cloth part 39 is taken up by the roll 41a being rotated by a not-shown drive apparatus.

In the wiping unit 30 of the embodiment, the cloth part 39 is interposed between the support plates 37 and the pressing plates 38. Therefore, sagging of the cloth part 39 between the supply unit 40 side and the take-up unit 41 side can be suppressed even in the case where the pad 35 is pressed by the nozzle 102 and the position of the pad 35 moves downward. Therefore, the adhered matter that is adhered to the nozzle 102 can be removed effectively.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A spiral coating apparatus, comprising:
a stage having a placement surface configured to have a coating object placed on the placement surface;
a nozzle configured to dispense a liquid onto the coating object placed on the stage;
a movement unit configured to move the nozzle relative to the stage, the movement unit including a first movement mechanism part and a second movement mechanism part, the first movement mechanism part being configured to move the nozzle in a direction parallel to a rotational axis of the stage, the second movement mechanism part being configured to move the nozzle along the placement surface in a direction intersecting the rotational axis;
a gas supply unit configured to supply a gas;
a cleaning liquid supply unit configured to supply a cleaning liquid; and
a nozzle cleaner having a gas supply port and a cleaning liquid supply port, the nozzle cleaner being configured to force the gas supplied by the gas supply unit from the gas supply port toward the nozzle and dispense the cleaning liquid supplied by the cleaning liquid supply unit from the cleaning liquid supply port toward the nozzle.

2. The apparatus according to claim 1, wherein the nozzle cleaner includes a housing configured to cover at least a portion of an outer circumference of the nozzle, the gas supply port and the cleaning liquid supply port being provided in the housing.

3. The apparatus according to claim 2, wherein the housing is a container having a hollow configuration.

4. The apparatus according to claim 2, wherein at least a portion of the nozzle is inserted into an interior of the housing.

5. The apparatus according to claim 2, wherein the housing has a gas passage, one end of the gas passage being used as the gas supply port.

6. The apparatus according to claim 5, wherein the gas passage is provided in an annular configuration around the entire circumference of the nozzle.

7. The apparatus according to claim 5, wherein the gas passage is multiply disposed around the entire circumference of the nozzle at a prescribed spacing.

8. The apparatus according to claim 2, wherein the housing has a cleaning liquid passage, one end of the cleaning liquid passage forming the cleaning liquid supply port.

9. The apparatus according to claim 8, wherein the cleaning liquid passage is provided in an annular configuration around the entire circumference of the nozzle.

10. The apparatus according to claim 8, wherein the cleaning liquid passage is multiply disposed around the entire circumference of the nozzle at a prescribed spacing.

11. The apparatus according to claim 8, wherein the cleaning liquid passage is provided at an outer circumferential portion of a lower end portion of the housing.

12. The apparatus according to claim 11, wherein the cleaning liquid passage is provided in an annular configuration around the entire circumference of a tip portion of the nozzle.

13. The apparatus according to claim 11, wherein the cleaning liquid passage is multiply disposed around the entire circumference of a tip portion of the nozzle at a prescribed spacing.

14. The apparatus according to claim 1, wherein the gas supply port is provided to be higher than the cleaning liquid supply port.

15. The apparatus according to claim 2, wherein the nozzle cleaner includes a third movement mechanism part configured to hold the housing, the third movement mechanism part being configured to move the housing relative to the nozzle in a direction parallel to an axis of the nozzle.

16. The apparatus according to claim 15, wherein the third movement mechanism part is held by the second movement mechanism part and is movable with the nozzle along the placement surface in the direction intersecting the rotational axis.

17. The apparatus according to claim 1, wherein the nozzle cleaner is configured to dispense the cleaning liquid supplied by the cleaning liquid supply unit from the cleaning liquid supply port toward the nozzle while forcing the gas supplied by the gas supply unit from the gas supply port toward the nozzle.

18. The apparatus according to claim 15, wherein the nozzle cleaner is configured to use the third movement mechanism part to move the housing toward a tip portion of the nozzle while forcing the gas supplied by the gas supply unit from the gas supply port toward the nozzle.

19. The apparatus according to claim 18, wherein the nozzle cleaner is configured to use the third movement mechanism part to move the housing toward a side opposite to the tip portion of the nozzle while forcing the gas supplied by the gas supply unit from the gas supply port toward the nozzle after lowering the housing toward the tip portion of the nozzle.

20. The apparatus according to claim 19, further comprising a wiping unit including a cloth part provided to be able to contact a tip surface of the nozzle,
the movement unit being configured to move the tip surface of the nozzle over the cloth part in a state of the tip surface contacting the cloth part while the nozzle cleaner forces the gas supplied by the gas supply unit from the gas supply port toward the nozzle after moving the housing toward the side opposite to the tip portion of the nozzle.
